(19) United States
(12) Patent Application Publication
(10) Pub. No.: US 2007/0121323 A1
(43) Pub. Date: May 31, 2007

(54) Light fixture with memory

(75) Inventors: Kay Pawlik, Plettenberg (DE); Jens Von Der Brelie, Frankfurt (DE)

Correspondence Address: THE FIRM OF KARL F ROSS, 5676 RIVERDALE AVENUE, PO BOX 900, RIVERDALE (BRONX), NY, 10471-0900, US

(73) Assignee: ERCO Leuchten GmbH

(21) Appl. No.: 11/439,889

(22) Filed: May 24, 2006

(30) Foreign Application Priority Data
May 24, 2005 (DE) 202005008322.4
Apr. 21, 2006 (DE) 102006019144.7

(51) Int. Cl. F21V 33/00

(52) U.S. Cl. 362/253

(57) ABSTRACT

A light fixture (10, 10a, 10b, 10c, 10d, 10e, 10f) is shown and described that is connectable via a signal line (11) with a controller and that has an electronically readable memory (15) holding an identifier of the light fixture, the identifier being transmittable via the signal line (11) to the controller (12).

The novelty is at least in part that the identifier is also held in a secondary memory (16, 19, 19b) associated with the light fixture.

The invention regards a light fixture according to the preamble of claim 1.

Such a light fixture is known to applicant from post-published German patent application DE 10 2005 009 228.4.

The known light fixture has an electronically readable memory that holds an identifier such as a serial number that can be read out electronically. The light fixture is connected with a signal line and is thus addressable by a controller. The controller can read out the identifier in the memory during installation and/or during putting in service and thus knows exactly which light fixture is connected to the controller. This is particularly advantageous for networks having a plurality of light fixtures. The installation effort is distinctly reduced with the light fixture described in the post-published patent application mentioned above.

If light fixtures with their own respective identifiers are e.g. arranged in different rooms and insofar as there is e.g. a large distance between the light fixture to be installed and the controller, so that visual contact between the controller and the light fixture is impossible, their installation and putting in service is indeed still complex. When each light fixture has been connected to the controller and installed, an operator must gradually address all elements, checking visually which light fixture is mounted at which place. The individual positions of each light fixture have to be visually checked. Moreover, this information concerning the installation site of the light fixture has to be communicated to the controller.

Therefore the invention is based on the object of further developing a light fixture according to the preamble of claim 1 so that simplified installation is rendered possible.

The invention attains this object with the features of claim 1, in particular with those of the characterizing clause and is accordingly characterized in that the identifier is also held in a separate secondary memory dedicated to the light fixture.

The invention initially requires that a light fixture be provided with an electronic memory that holds its own respective identifier. The identifier can particularly be a unique serial number, as described in the post-published German patent application mentioned before. Alternately the identifier can also be an identifier that individually characterizes the light fixture in a control system of light fixtures and allows an identification, for example a randomly assigned long number.

This identifier is now, according to the invention, not only held. In the memory that can be read out electronically and that permits transmission of the identifier to the controller over the signal line during installation, but additionally is held in a secondary memory as well. This secondary memory is for example mounted inside the light fixture and designed as an RFID (radio frequency identification tag) chip. In this case an operator can locate the light fixture installed at the application site, for example on a ceiling of a building with a portable reading device and thus carry out a wireless electronic read out of the identifier. The reader can memorize the position of the light fixture on the ceiling. Subsequently the operator can connect the controller with the reader and transfer the position data determined by the reader to the controller.

Alternately the identifier can be a bar code, a numerical or letter code and can be printed on a label that is removably attached to the light fixture or removably attached to the light fixture's shipping carton. The label can also be permanently fixed to the light fixture or to the light fixture's carton and be read out with an appropriate scanner or read-out device.

If it is a removable label that provides the secondary memory and carries the identifier, the person who carries out the installation can walk through the room, for example with a ceiling plan, thus with a chart that shows the ceiling's shape and the positions of the light fixtures, and can successively remove the labels from the mounted light fixtures and place them on the spots provided therefore on the ceiling plan. Since the identifier on the label is identical to the identifier transmitted to the controller over a signal line and situated in the memory of the light fixture that can be read out electronically, subsequent to transmission of the light fixture's position data to the controller, the controller can establish a link by means of the identifier situated on the label. Thus the controller receives the identifier in effect twice. One time the controller receives the identifier over the signal line and thus knows which circuit or which line connections were dealt with. The controller receives the identifier a second time together with position information through a transmission path separated thereof, namely for example through the operator or a portable reading device. The position information and the identifier already received can be linked without problems since the identification is identical. The controller thus can link this information and use it to operate the light fixtures after the installation of the light fixtures.

The installation effort thus is distinctly reduced. During installation not all the light fixtures have to be individually identified and checked with respect to their installation position by scanning. The operator can quickly remove the labels with the identifiers from the light fixtures or the light fixtures' packaging and attach the corresponding labels to the ceiling plan.

If the labels contain an identifier in the form of a bar code or a different sequence of signs the controller might have a bar-code reader that thus can read out the identifiers from the ceiling plan to which labels have been applied. Thus the controller can assign them to the identifiers received through the signal line.

It should be noted that the identifier held in the secondary memory is preferably identical to the identifier held in the memory that can be electronically read out. Alternately the identifier held in the secondary memory can also be an identifier linked to an identifier in the memory that can be associated electronically and allows as well reference back to this identifier. Therefore the identifier held in the secondary memory does not strictly have to be identical to the identifier held in the memory that can be read out electronically, but must have an explicit association with this identifier or allow at least a linking by the controller to the identifier transmitted over the signal line.

Furthermore, the invention relates to a light fixture according to the preamble of claim 12 and is therefore equally based on a light fixture as described in the post published German patent application DE 10 2005 009 228.4 of the applicant.

It is the object of the invention to further develop a light fixture according to the preamble of claim 12 such that a simpler installation is made possible.

The invention attains this object with the features of claim 12, in particular with those of the characterizing clause and is therefore characterized in that the light fixture disposes of a further transmission path that is independent of the signal line and by means of which the identifier can be read out during installation of the light fixture at the installation site.

The principle of this invention consists in that the identifier can not only be transmitted to the controller over the signal line, but that a separate transmission path is provided that allows the identifier to be read out during installation of the light fixture at the application site. The separate transmission path may for example allow a wireless read out, if for example the memory can be read out both electronically by means of the signal line and wirelessly by an adequate reader, which is provided with a transmitter and a receiver.

The advantages resulting according to the independent claim 12 from the idea according to the invention correspond to the advantages according to claim 1 described before, with the only difference being that no separate secondary memory is included and a separate transmission path is proposed instead.

Further advantages of the invention arise from the not cited subclaims, as well as by means of the following description of several exemplary embodiments illustrated in the figures. Therein:

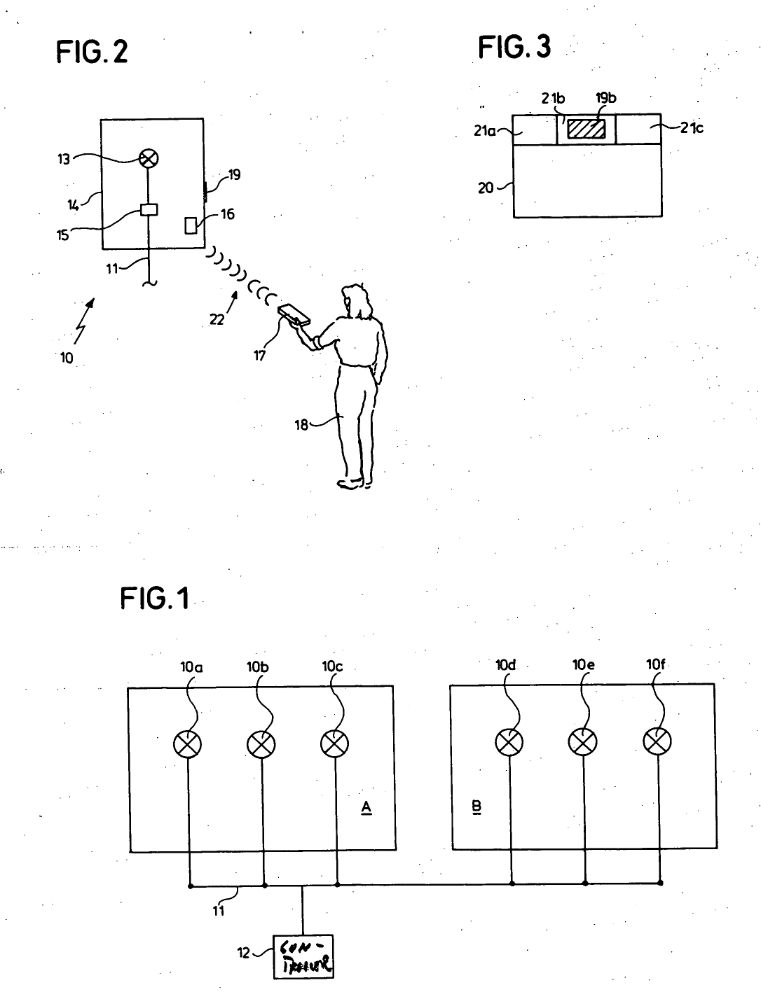

FIG. 1 shows in a very schematic illustration similar to a block diagram, a control system for several light fixtures with a controller and a signal line to which six light fixtures are connected that are mounted in two different rooms.

FIG. 2 shows a light fixture according to the invention that has an secondary memory and an operator who carries out a read-out process of the identifier from the secondary memory; and

FIG. 3 a ceiling plan according to the invention.

The light fixture as a whole according to the invention is indicated with 10 in the following figures. It should be noted that for reasons of clarity, even if different exemplary embodiments are described, the same or comparable parts or elements are indicated with the same reference signs, sometimes with lower-case postscripts.

In FIG. 2 a light fixture 10 according to the invention is illustrated in a very schematic overview. The light fixture 10 typically comprises at least one lamp 13 and usually, but not strictly necessary, a housing 14. Furthermore, the light fixture has a memory 15 that can be read out electronically and in which is written an identifier which allows identification of this light fixture 10, for example in the form of a factory-assigned serial number or as well in the form of a longer random number.

FIG. 1 shows a first room A and a room B separate therefrom in a very schematic, simplified illustration. In the room A are mounted three light fixtures 10a, 10b and 10c which are only schematically indicated. In the room B three light fixtures 10d, 10e and 10f are mounted, again only schematically indicated.

Each of the light fixtures 10a, 10b, 10c, 10d, 10e, 10f corresponds in its basic structure to e.g. a light fixture 10 according to FIG. 2. Each of the light fixtures 10a, 10b, 10c, 10d, 10e, 10f has its own, different identifier and therefore respectively has its own memory which can be read out electronically.

The light fixtures 10a, 10b, 10c, 10d, 10e, 10f are connected to each other by means of a shared signal line 11, as well as to at least one controller or control center 12. The controller 12 can control the network of light fixtures after their installation and address each single light fixture 10a, 10b, 10c, 10d, 10e, 10f.

It should be noted that both the number of rooms and the number of light fixtures in the embodiment are only exemplary. Furthermore it should be noted that for reasons of clarity the illustration of the typically provided power supply lines was avoided here. The signal line 11 typically is a twin wire or multiconductor line and can for instance also transmit information according to the DALI protocol.

In the following the basic problem during installation of the light fixtures 10a, 10b, 10c, 10d, 10e, 10f and the solution according to the invention are described:

It is assumed that the light fixtures 10a, 10b, 10c, 10d, 10e, 10f have just been installed in the two rooms A and B and are connected to the signal line 11. The controller 12 now can carry out a routine, gradually retrieving of the information regarding which light fixtures are connected to the network for example by sending corresponding commands to the individual light fixtures.

Since every single light fixture 10a, 10b, 10c, 10d, 10e, 10f has a different identifier in its own memory, the controller realizes very quickly which light fixtures are connected. It does not know yet, however, where the light fixtures are situated in the rooms A and B, or whether the light fixtures were installed at the right place. Therefore it is necessary that position information concerning the installation position of the single light fixtures be transmitted to the controller.

Up to now for this purpose it was necessary for an operator to enter for example room A and to therefore try to turn on the light fixture 10a. The controller 12, however, can be connected to a number light fixtures, for example 64 or 128 or even more. Since the controller 12 already knew that and which light fixtures were connected to it, but in that particular moment did not know yet where the individual light fixtures were actually situated, it was necessary for the operator to successively try to turn on every single light fixture, until the corresponding light fixture 10a, for instance, flashes or send some other light signal. It is obvious that such an installation effort was very time-consuming, especially if a plurality of rooms was concerned and a plurality of light fixtures was connected to the controller.

According to the invention the light fixture 10 according to FIG. 2 now has an secondary memory, for example a label 19 that forms the secondary memory. The secondary memory also holds the identifier written into the memory 15. The label 19 can for example have a bar code that contains the identifier as a sequence of bars or characters, if necessary encoded or enciphered. The label 19 can for example be removably attached to the light fixture 10 and can be removed from the light fixture 10 by the operator 18 after the installation of the light fixtures at the application site and during the installation of the light fixtures.

The label 19 can be glued onto a so-called ceiling plan 20 according to FIG. 3. In the simplest case the ceiling plan 20 is a diagram that (in the case of ceiling light fixtures to be installed) constitutes a schematic representation of the ceiling and shows the positions 21a, 21b, 21c that correspond to where the light fixtures 10a, 10b, 10c, 10d, 10e, 10f are to be installed on the actual ceiling of the room. The ceiling plan can for example comprise a room A only or all rooms A and B covered by the network.

It should be supposed that the operator 18 is in the room A and that henceforth the position of the light fixture 10b is to be captured. The operator 18 can remove a label 19b (not shown) mounted at the light fixture from the light fixture 10b and apply it to the ceiling plan 20 in the corresponding position 21b (FIG. 3). The label 19b contains the identifier of the light fixture 10b.

When all the light fixtures have been processed this way, the operator 18 can take the ceiling plan 20 and the labels situated thereon (e.g. 19a, 19b, 19c) to the controller and execute the read out of the corresponding identifiers by means of e.g. a bar-code reading device. This way the bar-code reading device can be connected to the controller during the installation routine such that the controller gets the position of the light fixture 10b in the room through the position field 21b on the ceiling plan 20 with the corresponding label 19b and assigns it thanks to the identifier received from the label to the identifier of the light fixture 10b received through the signal line. Thus the controller now knows the actual position of the light fixture 10b.

Alternately to the bar code read-in of the identifier, the label 19 can for example contain as well a RFID circuit chip (radio frequency identification) or circuit that also disposes of the identifier and allows wireless activation by a portable reading device or by the controller, if the reader or the controller are provided with a corresponding read-out device for the RFID chip.

FIG. 2 alternately shows in the label 19 a memory 16, that again is forms a secondary memory and contains the identifier. The secondary memory 16 as shown in FIG. 2 is for example an RFID chip fixedly mounted on the light fixture and that can be wirelessly read out by means of a portable reading device 17 as indicated by radio waves 22. The reader 17 correspondingly has a transmitter and a receiver and can be used by the operator 18 in the room. Furthermore, the reader 17 can memorize the position of the just captured light fixture or of the just captured RFID chip and transmit this position information later to the controller in a not further illustrated manner that is, however, clear for the professional.

In addition to RFID techniques other comparable techniques like Bluetooth, radio communication or every other optical or electromagnetic transmission of data, namely the identifier, from the secondary memory to the reader 17 can be used.

Finally it should be noted that the secondary memory with the identifier, e.g. a label 19 with a bar code, with an RFID chip or with a different memory for the identifier can be mounted directly on the light fixture 10, or can be mounted as well on the packaging of the light fixture, for example. It is however critical that the identifier be associated with the actual location of the site where the light fixture is used or mounted.

For example, the identifier can also be held in a memory that can be read out electronically from the packaging and that allows a read-out via an electric connection between the reader and the secondary memory.

Thanks to the procedure according to the invention visual contact between the operator in the single rooms and the controller that is necessary in the state-of-the-art, is no longer essential. Thus the installation effort can be distinctly reduced. Also, a very time-consuming checking of every single light fixture connected to the controller becomes superfluous.

Input of the identifier read out from the secondary memory into the controller can be carried out manually with the help of an operator, by means of a scanning procedure by a bar code reader or by further appropriate procedures. It is critical that thanks to the separate transmission path via the operator or reader, a particularly easy and time-saving assignment is rendered possible.

In the easiest case, the identifier is held as a written code, for example as a sequence of numbers, on the light fixture's carton or directly on the light fixture and can be copied by an operator. For example, the operator can directly write the cipher sequence on the ceiling plan and thus establish the spatial assignment of the light fixture to its place of installation by manually inputting the number code into the controller after all light fixtures have been entered.

Complementarily it should be noted that in a not illustrated embodiment, the memory 15 of the light fixture 10 according to FIG. 2 containing the identifier, on the one hand allows transfer of the identifier to the controller 12 over the signal line 11 and on the other hand permits a read out of the identifier by a portable reading device through a separate transmission path. For example, in this case the electronic memory 15 can permit, in addition to a read out through the signal line 11, a read out over a wireless connection to a portable reading device, for example by means of radio waves, by means of Bluetooth or by means of other wireless transmission systems.

It should be noted that it is not important in the embodiments according to the invention that the identifier contained in the memory which can be read out electronically be initially transmitted to the controller over the signal line or whether the identifier contained in the secondary memory is initially transmitted to the controller over the alternate transmission path. It is critical that both elements of the information, that is the position information regarding the light fixture and the information regarding which light fixture is connected to the controller by which cable, or respectively the information that a particular light fixture is connected to the signal line, be collected in the controller and therefore permit them to be associated with one another. The light fixture identified by the identifier can always be separately addressed by the controller and the information received through the traditional transmission path regarding the position of the light fixture can be associated with the address information.

Furthermore it should be noted that the identifier contained in the memory that can be read out electronically, can be replaced by a short address or system address, during installation or after putting the light fixture in service. This system address allows a target-aimed, separate addressing of the single light fixtures. Depending how the software for the putting in service the light fixtures is provided with single program steps, the position information received by the controller regarding the installation location of the light fixture can either be directly linked with the identifier received through the signal line or alternately with the system-related short address.

Furthermore, it should be noted that in the scope of the present patent application, a sort of gradual transmission of the identifier to the controller, e.g. manual or with interconnected readers, constitutes a separate transmission path. Transmission of the identifier, for example by means of a scanned bar code on the label on the light fixture, as well as the transfer to the controller of this scanned information, together with position information, if necessary manually input, are considered an alternative transmission path to the transmission path provided by the controller in the sense of the present patent application.

Furthermore, it should be understood that the term “light fixture” as used in the present patent application comprises light fixtures having an operator device, for example an electronic ballast, as well as light fixtures not having such an operator device. Consequently, the electronically read-out memory 15 can be mounted both at the light head, that is at the part of the light fixture containing the lamp, and at an operator device, e.g. an electronic ballast, which can be separately connected to the light fixture.

Finally it should be noted that the post-published German Patent application DE 10 2005 009 228.4 cited before, as well as a further, also post-published German patent application DE 10 2005 024 449.1 that also derive from the applicant are herewith included in the content of the present patent application, also with reference to single features. This also relates to the definition of some terms and connections used in the present patent application so that in order to avoid repetition one is referred to the content of these two post-published patent applications.

1. A light fixture (10, 10a, 10b, 10c, 10d, 10e, 10f) connectable via a signal line (11) with a controller and having an electronically readable memory (15) holding an identifier of the light fixture, the identifier being transmittable via the signal line (11) to the controller (12), characterized in that the identifier is also held in a secondary memory (16, 19, 19b) associated with the light fixture.

2. The light fixture according to claim 1, characterized in that the identifier is readable from the secondary memory (16, 19, 19b) when the light fixture is installed and/or put into service.

3. The light fixture according to claim 2, characterized in that the identifier is manually readable from the secondary memory (16, 19, 19b) when the light fixture is installed and/or put into service.

4. The light fixture according to claim 2, characterized in that the identifier is readable by a portable device from the secondary memory (16, 19, 19b) when the light fixture is installed and/or put into service.

5. The light fixture according to claim 1, characterized in that the identifier is readable from the secondary memory electronically and/or electromagnetically and/or optically.

6. The light fixture according to claim 1, characterized in that the identifier read from the secondary memory is transmittable via a transmission path (22) separate from the signal line to the controller.

7. The light fixture according to claim 1, characterized in that the identifier is transferred from the secondary memory to the controller indirectly, for example manually by use of a ceiling plan (20) or by means of a reader (17).

8. The light fixture according to claim 1, characterized in that the secondary memory is part of a label (19) or is formed as a label (19).

9. The light fixture according to claim 1, characterized in that the identifier is held in the secondary memory as a character code, in particular a bar code, and is printed on a label.

10. The light fixture according to claim 1, characterized in that the secondary memory is an RFID chip.

11. The light fixture according to claim 1 characterized in that the secondary memory is separable from the light fixture (10, 10a, 10b, 10c, 10d, 10e, 10f) or is carried on a part associated with the light fixture, in particular its packaging.

12. A light fixture (10, 10a, 10b, 10c, 10d, 10e, 10f) connectable via a signal line (11) with a controller and having an electronically readable memory (15) holding an identifier of the light fixture, the identifier being transmittable via the signal line (11) to the controller (12), characterized in that there is for the light fixture a further transmission path (22, 17) independent of the signal line and through which the identifier can be read during or after final installation of the light fixture.
